(19) United States
(12) Patent Application Publication
(10) Pub. No.: US 2008/0140599 A1
(43) Pub. Date: Jun. 12, 2008

(54) SYSTEM AND METHOD FOR DETECTING HEALTHCARE INSURANCE FRAUD

(76) Inventors: Debra Pacha, Oviedo, FL (US); Raul Ariza, Oviedo, FL (US); Stephen Ratcliff, Oviedo, FL (US)

Correspondence Address: McKinney Law, LLC, 390 N. Orange Avenue, Suite 2300, Orlando, FL, 32801, US

(21) Appl. No.: 11/938,582

(22) Filed: Nov. 12, 2007

Related U.S. Application Data
(60) Provisional application No. 60/865,400, filed on Nov. 10, 2006.

(51) Int. Cl. G06N 5/02

(52) U.S. Cl. 706/47

(57) ABSTRACT

The invention comprises a method and system of detecting and identifying fraud arising from a healthcare claim. The system includes a storage means for storing a data base containing source data related to a healthcare claim. A memory means is used for storing a set of user-defined rules for detecting and identifying fraud. A processing means is coupled to the storage means for comparing the source data to the set of rules in the memory means. If the source data violates the set of rules, the relevant portion of the source data is identified and flagged as fraudulent data. The flagged data is then forwarded to a special investigator for a comprehensive analysis. The fraudulent data is transformed to graphs and charts to illustrate patterns so that the fraud is easily detected and identified.

### CROSS-REFERENCED TO RELATED APPLICATIONS

This application claims the benefit of U.S. Provisional Application No. 60/865,400 filed Nov. 10, 2006. The disclosure of the provisional application is incorporated herein by reference.

### BACKGROUND OF THE INVENTION

1. Field of the Invention

The present invention relates generally to the healthcare industry, and more specifically to analyzing data submitted to healthcare providers and detecting fraudulent activity.

2. Background of the Invention

Though industry experts say that the cost of fraud in the healthcare industry is as high as $80 billion each year which is passed on to consumers in the form of higher premiums, many healthcare insurers are reluctant to hire Special Investigative Units (SIU's) to uncover and fight fraud because they are perceived as costly and a risk that could potentially expose the insurer to bad-faith lawsuits. SIU's are usually made up of a team of highly trained investigators that have a multitude of experience in the claims and/or law enforcement field. Traditional claims investigations take many hours to complete and experienced investigators generally command high salaries. Vast amounts of claim forms and medical documentation has to be sorted, studied, and compared to industry guidelines, national/international rules and regulations, as well as state laws for the investigator to arrive at an opinion as to whether fraud has been detected.

Accordingly, there is a need in the art for a method and system that enables an investigator to analyze data and to detect fraud much faster, saving time and money for insurance companies, SIU agents, Federal agencies (DHHS), federal government, adjusters, claims management and state departments.

There is also a need in the art for a method that generates output from the data analyzation that is flexible so that it can be provided to an expert witness for evaluation or sent to attorney or insurance carrier without unnecessary, privileged or confidential information.

There is a need in the art for a method and system that reduces labor-intensive responsibilities and lowers overall expenses of analyzing the data but maintains quality assurance capabilities.

There is a need in the art for a method and system that has the ability to analyze the data across multiple healthcare providers, unique physician/practitioner identification numbers (UPIN#s), national provider identifier numbers (NPI#s), tax identification numbers (TIN#s), patient/claimants, occurrences, procedures, diseases/conditions and provider charges.

There is a need in the art for a method and system that has the ability to analyze patterns within the data and to generate user-friendly reports and color-coded graphs/charts.

There is a need in the art for a method and system that allows a user to define rules that generate an alert or flag contemporaneously with the analyzation of the data when the data being analyzed meets the user-defined set of rules.

There is a need in the art for a method and system that is adaptable to a user's specialized areas of interest for specific investigative projects.

There is a need in the art for a method and system with a user reference library on instructions on the proper use of medical equipment, clinic inspection techniques, manufacturer specs of diagnostic equipment, required OIG Physician Compliance Program information, appropriate medical record keeping requirements, definitions of HCPCS/CPT and ICD-9/ICD-10 codes, which are relevant to the data analyzation and fraud detection.

There is also a need in the art for a method and system that is flexible to adapt to meet a healthcare provider, insurers, legal counsel, SIU and Federal Government needs in terms of generating output, access, flags, patterning and search criteria.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY OF THE INVENTION

The present invention comprises a method and system of detecting and identifying abuse, over-utilization and fraud arising from a healthcare claim. The system includes a storage means for storing a data base containing source data related to a healthcare claim. A memory means is used for storing a set of user-defined rules for detecting and identifying fraud. The set of rules includes, but is not limited to, a history rule to determine if a proper history and examination of a claimant was performed prior to ordering a diagnostic test; a quantity rule to determine if diagnostic tests ordered correlate to a localized area of suspected involvement; an unbundled rule to determine if separate bills were submitted for bundled services; a multidisciplinary rule to determine if different medical specialties are located at a sole facility and billing unnecessary diagnostic procedures; an interpretation rule to determine if an additional charge for interpreting diagnostic results previously incorporated with fees for the diagnostic test is warranted; a timing rule to determine if the time between a diagnostic test and interpretation of the results indicates the diagnostic test was unnecessary. A processing means is coupled to the storage means for comparing the source data to the set of rules in the memory means. If the source data violates the set of rules, the relevant portion of the source data is identified and flagged as potentially fraudulent data. The flagged data is then forwarded to a special investigator for a comprehensive analysis. The fraudulent data is transformed to graphs and charts so that the fraud is easily detected and identified.

Raw data such as accident reports, hospital records, medicolegal documents, and all billing including, but not limited to, the Universal Claim Form—HCFA/CMS-1500 and UB-92/UB-04 claim forms, or their equivalent, superbills, etc., are scanned and input to the system in a precise method as source data. The source data is mined via a maximum security link over the Internet, or input by hand by specified individuals with Quality Assurance (“QA”) provided to insure a zero factor error rate. Information regarding what type of document comprises the source data is entered and retained in the system for identification with specific sorting capabilities.

The present invention does not limit the amount or type/format of information that can be entered as source data. Information entered can be anything from photographs to lab reports, ledgers, legal documents to handwritten doctor's notes and sticky post notes. All source data is scanned, and bate stamped when applicable, for later sorting and analysis. Optical character recognition (“OCR”) capabilities are utilized within the present invention.

An advantage of the present invention is that after source data is entered, it is processed through an audit module, which analyzes and compares source data for billing and coding irregularities based on the set of user-defined rules. The present invention utilizes extensive intelligence procedures to compare source data and identify indicators of fraud found within the coding/billing and documentation process. These indicators of fraud, or “red flags”, support claims management, agents, and counsel to detect and prevent fraud.

Another advantage of the present invention is that it can generate easy to read reports. These easy to read and understand reports enable a less skilled person to effectively and proficiently review the medical files for irregularities and visualize the fraud. Utilizing the present system provides an efficient, paperless environment to review/examine the source data without altering the integrity of the original documentation. Additionally, the detailed reports provide clarity, preciseness, and accuracy in the demonstration of abusive behavior when presented in trial testimony. These reports and color coded graphs serve as visual exhibits at trial to illustrate where fraud is being committed for those who are generally not experienced in the medical arena.

Another advantage of the present invention is that it can contain an available library of inspection tools designed to assist government officials, claims management, SIU agents, and counsel with their investigation into the case or cases. These inspection tools can include, but are not limited to, instructions on the proper use of medical equipment utilized in diagnostic testing and/or treatment, clinic inspection techniques and diagnostic procedure protocols, manufacturer specification of diagnostic equipment, appropriate medical record keeping requirements and definitions of commonly used acronyms, definitions of HCPCS/CPT® and ICD-9/10 codes, and rules and guidelines of medical billing procedures.

Yet another advantage of the present invention is the ability to duplicate and output data for use under an Independent Medical Examination (IME) and Peer Review. The IME/Peer Review component of the present invention organizes the source data into an overview window, a scheduling window, IME appointments window, IME/Peer Review physicians window, patient information window, IME/Peer Review report storage, letters log, and letter editor. This embodiment of the invention allows for additional input as an IME/Peer Review case progress to aid with organization and record keeping. A particular advantage to this embodiment includes the ability to automatically create and print IME/Peer Review request form letters to counsel, claimants/patients, physicians, and insurers.

It is therefore a primary object of the invention to provide a method and system that enables an investigator to analyze data and to detect fraud much faster, saving time and money for insurance companies, SIU agents, Federal agency adjustors, and state departments.

Another important object of the present invention is to provide a method that generates reports that are flexible so that it can be provided to an expert witness for evaluation or sent to attorney or insurance carrier without unnecessary, privileged or confidential information.

Another important object of the present invention is to provide a method and system that reduces labor-intensive responsibilities and lowers overall expenses of analyzing data but maintains quality assurance capabilities.

Another important object of the present invention is to provide a method and system that has the ability to analyze the data across multiple healthcare providers, tax identification numbers, patient/claimants, occurrences, procedures, disease/conditions and charges.

Another important object of the present invention is to provide a method and system that has the ability to analyze patterns within the data and to generate user-friendly reports and color-coded graphs/charts.

Another important object of the present invention is to provide a method and system that allows a user to define rules that generate an alert or flag contemporaneously with the analyzation of the data when the data being analyzed meets the user-defined rules.

Another important object of the present invention is to provide a method and system that is adaptable to a user's specialized areas of interest for specific investigative projects.

Another important object of the present invention is to provide a method and system with a user reference library on instructions on the proper use of medical equipment, clinic inspection techniques, manufacturer specs of diagnostic equipment, required OIG Physician Compliance Program information, appropriate medical record keeping requirements, definitions of HCPCS/CPT and ICD-9/10 codes, which are relevant to the data analyzation and fraud detection.

Another important object of the present invention is to provide a method and system that is flexible to adapt to meet healthcare providers, insurers, legal counsel, SIU and Federal Government needs in terms of generating output, access, flags, patterning and search criteria.

These and other important objects, advantages, and features of the invention will become clear as this description proceeds.

The present invention, accordingly, comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a flow diagram illustrating the fraud detection system in accordance with an embodiment of the present invention;

FIG. 2 is a flow diagram illustrating a data entry and quality control system of the fraud detection system in accordance with an embodiment of the present invention; and

FIG. 3 is a flow diagram illustrating a scanning system of the fraud detection system in accordance with an embodiment of the present invention.

### DETAILED DESCRIPTION OF THE PREFERRED EMBODIMENT

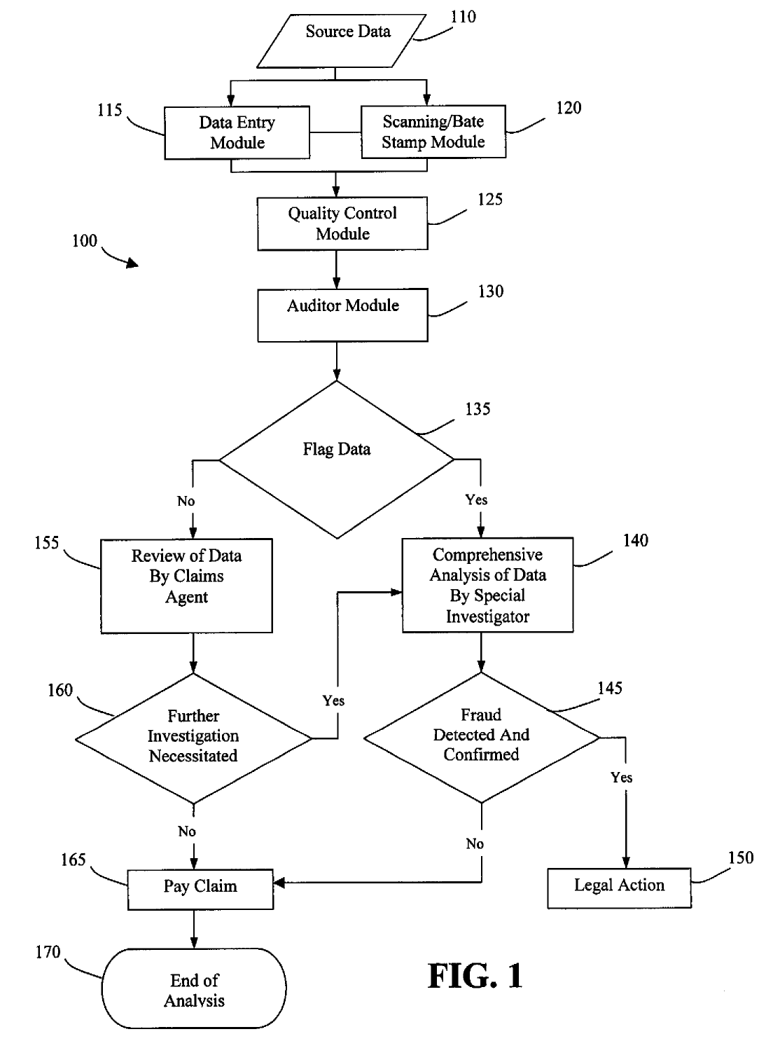

FIG. 1 is a flow diagram illustrating the steps of a fraud detection method in accordance with an embodiment of the present invention. Source data 110 is provided from various forms such as HCFA/CMS (1500), UBP2/UB-04 (1450), accident reports, emergency transportation forms, superbills/travel sheets, EOBs, etc. The hard copy of the documents that comprise the source data 110 is captured by scanning module 120 and preferably stored digitally. The pertinent information from the source data 110 is also entered using data entry module 115. The next step in the fraud detection method is to validate the accuracy of the data entered via data entry module 115 using quality control module 125. Quality control module 125 cross-checks the data entered into the system with either the digital image of the document or the actual hard copy. Often times it is more convenient to cross-check against a digital image rather than having to store and transport thousands of hard copies of source data 110.

Auditor module 130 includes a set of rules for comparing to source data 110 will detect indicators of fraudulent activity when the data violates the pre-determined set of rules. The data is flagged 135 for further comprehensive analysis by a special investigator 140 if indicators of fraud are detected. If no data is flagged so that no indicators of fraud were detected then the data is forwarded to a claims agent for review 155.

The set of rules employed by auditor module 130 are comprised of algorithms that analyze data for specific indicators of fraud. An example of an indicator of fraud included in the set of rules of auditor module 130 is the lack of adequate history, examination and medical decision making by a doctor when ordering or performing the diagnostic tests. This includes performance of EMG and nerve conduction studies without the claimant having had full neurological examination of motor, sensory or reflex function. It also includes visual evoked potentials (“VEP”) without the doctor having first performed visual acuity testing. Another example is performance of a brainstem auditory evoked response (“BAER”) without the doctor having first evaluated cranial nerve functions or determined the thresholds of hearing. Also, it is necessary to identify whether the claimant was on pain medication (i.e., Lortab, Vicodin, Lorcet, etc.) when these diagnostic tests were performed as the pain medication could significantly distort the results.

Another indicator of potential fraud included in the set of rules of auditor module 130 is detecting a large number of diagnostic tests ordered at once. Diagnostic tests should be done to confirm suspected diagnosis. Therefore, the diagnostic test should be ordered within areas of symptoms and possible findings on examination. It is not appropriate to order numerous diagnostic tests to look at the entire body without any correlation to the history and examination or the localized areas of suspected involvement.

Yet another indicator of fraud is the unbundling of services. History and examination that includes a charge for the history and examination as well as additional charges for muscle testing, range of motion testing, cognitive testing and interpretation. All of these additional services should be included within the fee for the doctor's history and examination. They are not justified as separate bills and are detected by auditor module 130 as an indication of fraud.

Facilities that employ multiple types of medical specialties (i.e., chiropractic, orthopedic, physical therapy, massage therapy, neurology) all under the same roof are susceptible to fraudulent practices. These types of facilities ultimately have a higher percentage of referrals along with numerous diagnostic procedures and physical therapy modalities. Within the same facilities, some of the disciplines bill under a street address while other disciplines bill from a PO box. Prior art audit systems do not have the ability to catch this type of abuse, multiple high complexity E&M consult codes and other CPT codes are paid without review. However, auditor module 130 of the present invention analyzes tax identification numbers of each medical specialist to detect this type of fraudulent activity.

An additional charge for interpretation of diagnostic tests is another indicator of potential fraud. These additional charges should be included within the fees for the diagnostic tests when no modifier (e.g., “TC”) is added to the CPT code to indicate that this procedure is being billed for only the technical component. This would then reduce the fee for the diagnostic test. Any additional charges from the interpreting doctor should have a modifier by the same CPT code to indicate only the interpretation of the diagnostic test. The total costs of the bill for the technical aspect of the diagnostic test and the interpretation of the results of the diagnostic test would then equal the UCR/RBRVS of that specific CPT code. Accordingly, auditor module 130 flags data that identifies inconsistency related to this fraudulent activity.

Another indicator of potential fraud that auditor module 130 detects is the problem in the timing of certain medical procedures. This includes the performance of some tests too early (e.g., needle EMG performed, less than three weeks post injury), as well as long intervals between the order of diagnostic tests and the performance of the tests. There is significant cause to question the medical necessity of a diagnostic test when it is performed but not interpreted until weeks or months later. Another indicator is when an electrodiagnostic tests are scheduled and/or performed with a long interval of time between the comprehensive neurological history and examination. EMG and nerve conduction studies (as well as somatosensory evoked potentials (“SSEPs”) are extensions of the neurological examination. There should be evidence of an updated thorough neurological examination not too long before the performance of the EMG and nerve conduction study or somatosensory evoked potential. Accordingly, auditor module 130 flags data related to this type of timing discrepancy.

Boilerplate type form letters of necessity are another indicator of potential fraudulent activity. Often printed years prior are form letters stating the need and medical necessity of the diagnostic testing/procedure to be performed and not referring or relating to the claimant in question. Generic letters of necessity are not adequate and do not address a specific claimant's problems or reasons for testing.

Diagnostic procedures billed with a CPT code ending with 99 (i.e., “95999”, “76499”, etc.) are also problematic because this indicated the procedure performed is unlisted and prior art audit systems do not identify this resulting in a payment without inquiring about the procedure. When questioned or investigated, a typical response is “computer generated billing errors.” In any event, auditor module 130 flags this data for further comprehensive review 140 to determine whether it is in fact a computer error or fraud.

Audit module 130 resides on a computer that may be configured in a number of different forms for accepting input, processing the input according to specified instructions, and outputting the processing results, as is well known in the art. The computer may be, for example, a personal computer, a workstation, a supercomputer, a mainframe computer, a minicomputer, a handheld computer, a wearable computing device, a personal digital assistant (“PDA”), a smart appliance in the home, and so forth. By way of example, the computer may function as a server in the client/server architecture in a networking environment; alternatively, the computer may be a client device in the client/server architecture, a device operating within another networking environment, or a stand-alone device not operating within a networking environment. In accordance with the preferred embodiment of the present invention, audit module 130 includes a processing means comprising a central processing unit (“CPU”). The CPU is preferably one of the Intel families of microprocessors, one of the Advanced Micro Devices, Inc. families of microprocessors, one of the Motorola families of microprocessors, or one of the various versions of a Reduced Instruction Set (“RISC”) microprocessor such as the PowerPC® chip manufactured by IBM.

Audit module 130 includes a memory means comprising random access memory (“RAM”) and read-only memory (“ROM”). In preferred embodiments, ROM stores various controlling programs and RAM is preferably used for loading an operating system and selectively loading controlling programs and/or application programs.

As indicated in FIG. 1, if no fraud indicators are identified by auditor module 130, the data is passed along to the claims agent for review 155. The claims agent reviews the data and determines the next necessary action 160 to pay the claim 165, order a peer review and/or baseline IME, or authorize a comprehensive analysis of the data by a special investigator 140. As part of the comprehensive analysis by the special investigator 140, the investigator follows up or carries out inspections, surveillance, and/or runs data patterning algorithms to detect fraudulent activity and generate user-friendly reports and graphs to illustrate the fraud. If fraud is in fact identified 145, ten legal action 150 or other appropriate action can be taken with the evidence of the fraud clearly identified. Otherwise, if no fraud is discovered after a comprehensive analysis 145, the claim is paid 165 and the analysis completed 170.

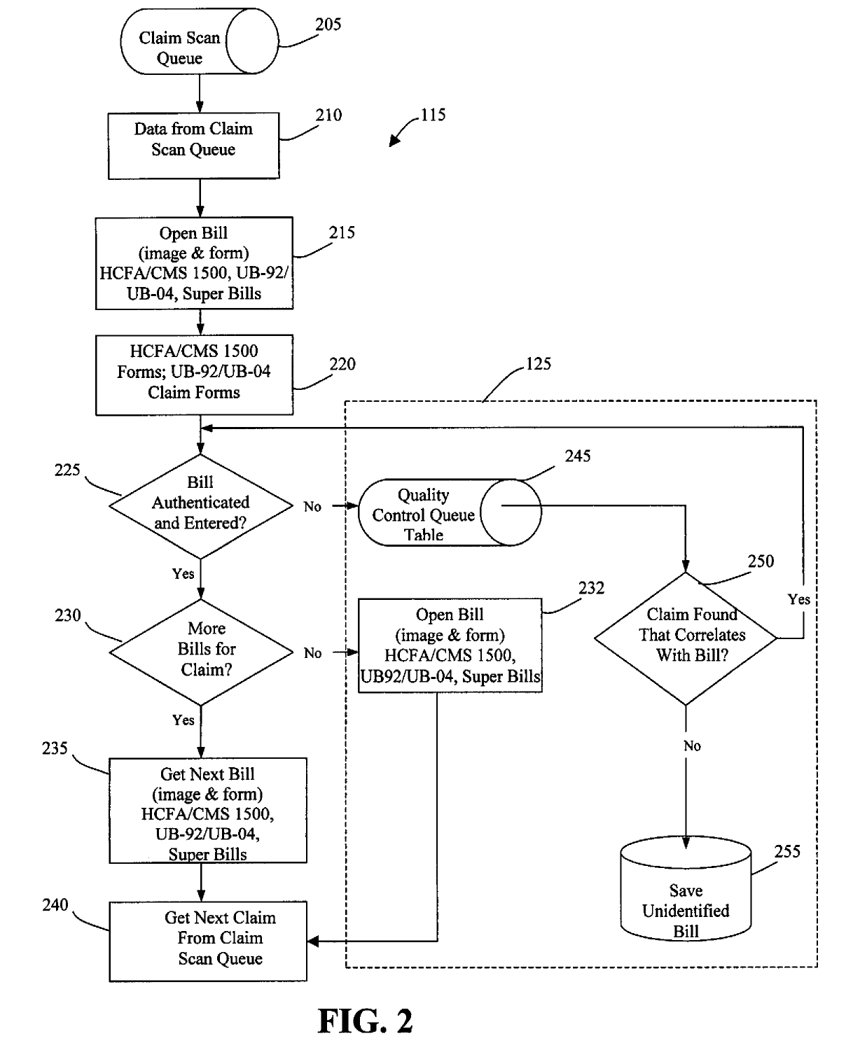

Referring now to FIG. 2 illustrates the data entry module 115 and quality control module 125 of the present invention. Data that has been scanned is first stored in a claim scan queue 205. The storage means of claim scan queue may be one or more fixed or removable computer-readable media that is electrically, magnetically, optically, chemically, or otherwise altered to store computer-readable program code, where this media is readable by a device such as disk drive. In other embodiments claim scan queue 205 may be one or more other computer-readable media, such as a CD-ROM disk. Alternatively, claim scan queue 205 or portions thereof may be downloaded to RAM via a network. In other embodiments of claim scan queue 205, claim scan queue 205 can be partially or fully implemented with digital circuitry, analog circuitry, or a combination thereof.

Next, data from a desired claim is accessed from the claim scan queue 210. The data includes CMS 1500, UB92, Super Bills among other types of various data. The electronically stored image is opened 215 and can be viewed by the user including the HCFA forms 220. The bill is then authenticated and entered 225. If the bill is not authenticated and entered it is processed by a quality control queue table 245 to determine the origin of the bill and/or to address the reason why the bill could not be authenticated. If the claim that correlates with the bill is found 250 or the issue is otherwise resolved, the bill is returned to be authenticated an entered 225. Conversely, if the bill cannot be correlated to a claim, then the bill is stored and isolated 255. The data entry module 115 determines whether there are any additional bills for the claim 230 so that it can retrieve the additional bills 235 for authentication and entry 225 until all the bills for that claim have been processed. Once all the bills for the claim have been processed, the data entered into the system 100 is manually checked 232 to verify the accuracy of the data entry.

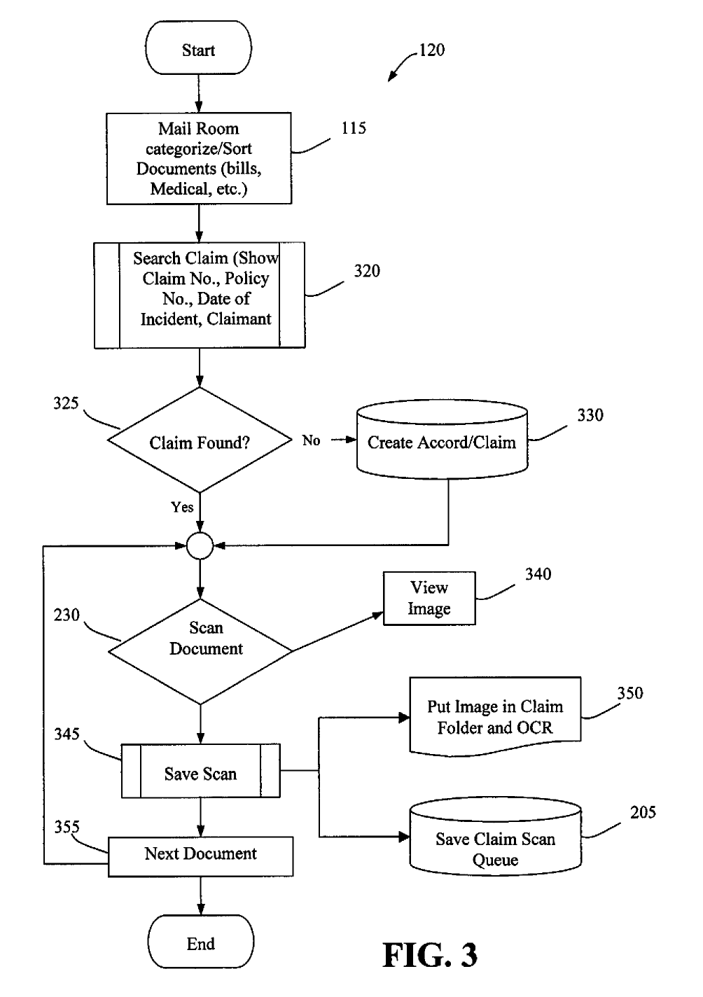

As shown in FIG. 3, the scanning module 120 begins with the collection of the various documents 315 that comprise source data 110 for system 100. The next step is to search system 100 to determine whether a claim exists 320. If a claim is found 325, then the document is scanned 335 and saved to storage 345. This includes saving the image in the claim's folder 350 and to the claim scan queue 205. This process is repeated until all source data 110 has been scanned and saved to storage. The image can be viewed 340 prior to saving for quality control purposes. Alternatively, if a pre-existing claim is not found 325, then a claim file is first created 330 and the document is then scanned 335 and saved to storage 345.

As will be appreciated by one of skill in the art, embodiments of the present invention may be provided in various forms, including methods, systems, or computer program products. Accordingly, the present invention may take the form of an entirely hardware embodiment, an entirely software embodiment, or an embodiment combining software and hardware aspects. Furthermore, the present invention may take the form of a computer program product that is embodied on one or more computer-readable storage media (including, but not limited to, disk storage, CD-ROM, optical storage, and so forth) having computer-readable program code embodied therein.

The present invention has been described with reference to flow diagrams and/or block diagrams of methods, apparatus (systems), and computer program products according to preferred embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flow diagram flow or flows and/or block diagram block or blocks.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown. It is therefore evident that the particular embodiments disclosed above may be altered or modified and all such variations are considered within the scope and spirit of the invention.

It is also to be understood that the following claims are intended to cover all of the generic and specific features of the invention herein described, and all statements of the scope of the invention, which as a matter of language, might be said to fall there between.

Now that the invention has been described,

What is claimed is:

1. A method of detecting and identifying fraud arising from a healthcare claim, comprising the steps of:
creating a data base containing source data related to a healthcare claim;
selecting data from the data base to compare to a set of rules;
comparing the selected data to the set of rules;
identifying fraudulent data from the selected data when the selected data violates the set of rules;
flagging the fraudulent data for comprehensive analysis by a special investigator; and
generating a report from the fraudulent data illustrating patterns so that the fraud is visually identified by user-friendly graphs and charts.

2. The method of claim 1 wherein the source data includes accident reports, hospital records and billing claim forms.

3. The method of claim 1 wherein the step of comparing the selected data to the set of rules comprises comparing said selected data to a history rule of the set of rules when the selected data includes a bill for performing a diagnostic test.

4. The method of claim 1 wherein the step of comparing the selected data to a set of rules comprises comparing said selected data to a quantity rule of the set of rules when the selected data includes a bill for performing a large quantity of diagnostic tests.

5. The method of claim 1 wherein the step of comparing the selected data to a set of rules comprises comparing said selected data to an unbundled rule of the set of rules when the selected data includes a bill for history and examination of a claimant in addition to a battery of testing procedures such as muscle testing, range of motion testing, cognitive testing and interpretation.

6. The method of claim 1 wherein the step of comparing the selected data to a set of rules comprises comparing said selected data to a multidisciplinary rule of the set of rules when the selected data includes a bill for different medical specialties arising from the same billing address or tax identification number.

7. The method of claim 1 wherein the step of comparing the selected data to a set of rules comprises comparing said selected data to an interpretation rule of the set of rules when the selected data includes a bill for interpretation separate from the bill for performing a diagnostic test.

8. The method of claim 1 wherein the step of comparing the selected data to a set of rules comprises comparing said selected data to a timing rule of the set of rules when the selected data includes a bill for a diagnostic test.

9. The method of claim 1 wherein the step of comparing the selected data to a set of rules comprises comparing said selected data to a coding rule of the set of rules when the selected data includes a bill with a billing code that does not correlate to a table of billing codes.

10. A system of detecting and identifying fraud arising from a healthcare claim, comprising:
storage means for storing a data base containing source data related to a healthcare claim;
memory means for storing a set of rules for detecting and identifying fraud;
processing means coupled to the storage means for comparing the source data to the set of rules in the memory means and if the source data violates the set of rules identifying the source data as fraudulent data; and
means for flagging the fraudulent data for comprehensive analysis by a special investigator.

11. The system according to claim 10 farther comprising report generating means so that the fraudulent data is transformed to graphs and charts so that the fraud is easily detected and identified.

12. The system of claim 10 wherein the set of rules includes a history rule to determine if a proper history and examination of a claimant was performed prior to ordering a diagnostic test.

13. The system of claim 10 wherein the set of rules includes a quantity rule to determine if diagnostic tests ordered correlate to a localized area of suspected involvement.

14. The system of claim 10 wherein the set of rules includes an unbundled rule to determine if separate bills were submitted for bundled services.

15. The system of claim 10 wherein the set of rules includes a multidisciplinary rule to determine if different medical specialties are located at a sole facility and billing unnecessary diagnostic procedures.

16. The system of claim 10 wherein the set of rules includes an interpretation rule to determine if an additional charge for interpreting diagnostic results previously incorporated with fees for the diagnostic test is warranted.

17. The system of claim 10 wherein the set of rules includes a timing rule to determine if the time between a diagnostic test and interpretation of the results indicates the diagnostic test was unnecessary.

18. A computer program product for detecting and identifying fraud arising from a healthcare claim, the computer program product embodied on one or more computer-readable media and comprising:
computer-readable program code means for storing a data base containing source data related to a healthcare claim;
computer-readable program code means for storing a set of rules for detecting and identifying fraud related to the healthcare claim;
computer-readable program code means for comparing the source data to the set of rules;
computer-readable program code means for identifying the source data as fraudulent data if the source data violates the set of rules; and
computer-readable program code means for flagging the fraudulent data for comprehensive analysis by a special investigator.

19. The computer program product according to claim 18 wherein the set of rules includes a history rule, quantity rule, unbundled rule, multidisciplinary rule, interpretation rule, timing rule and coding rule for detecting and identifying fraud.

20. The computer program product according to claim 19, further comprising the step of generating reports from the fraudulent data so that the fraud is visually identified by user-friendly graphs and charts.
